(19) United States
(12) Patent Application Publication
(10) Pub. No.: US 2007/0125882 A1
(43) Pub. Date: Jun. 7, 2007

(54) Device for atomizing a liquid composition

(75) Inventors: Henri-Louis Schwal, Toulouse (FR); David Kassar, Toulouse (FR)

Correspondence Address: YOUNG & THOMPSON, 745 SOUTH 23RD STREET, 2ND FLOOR, ARLINGTON, VA, 22202, US

(73) Assignee: GLOSTER SANTE EUROPE, Labege Cedex (FR)

(21) Appl. No.: 10/585,401

(22) PCT Filed: Sep. 10, 2004
(86) PCT No.: PCT/FR04/02299

§ 371 Date: Feb. 12, 2007

(30) Foreign Application Priority Data
Sep. 12, 2003 (FR) 0310724

(51) Int. Cl. B05B 7/04

(52) U.S. Cl. 239/434; 239/426; 239/428

(57) ABSTRACT

A device for atomizing a liquid composition serves to treat a premises and equipment contained therein. The device is equipped with an atomizing nozzle including: a) a secondary duct (102) supplied with liquid and having an element (1) for effecting a first fractionation of the liquid inside an expansion chamber (2); b) a principle duct (101) flowed through by a gas stream and having an element (3) for effecting a second fractionation of the liquid, and; c) connecting element (5) for connecting a) and b). The nozzle can also be equipped with an ultrasonic resonator (21) and with a resonance chamber (22) situated in front of the discharge opening (4). Also disclosed is an atomizing method during which a first fractionation of the liquid is effected by suction through a first venturi (6), a second fractionation of the liquid is effected by suction into the gas stream while leaving a second venturi and, optionally, a third fractionation is effected by ultrasonic vibration.

The present invention relates to an apparatus for spraying a liquid composition intended for the treatment of areas and surfaces of premises and the equipment which is contained therein.

The dangers of premises being contaminated by germs present in the environment or brought from outside involve both people and, more especially, susceptible people such as children, elderly persons or invalids, as well as the furniture and equipment which may be situated therein. For example, all of the sites for which strict hygiene is required are involved, whether they are hospital premises, care centres, dental surgeries, plants for processing food products or other premises.

It has been established that a considerable and permanent exchange exists between surfaces and the atmosphere. Contaminants in suspension in the atmosphere settle on surfaces, depositing gems there which are subsequently transmitted by the hand-borne method. Conversely, airborne contamination results from the suspension in the surrounding air of the microorganisms present on the surfaces. Awareness of the dangers of cross-contaminations and the adoption of stricter regulatory provisions in the matter of sanitary prevention and disinfection calls for new solutions.

Now, at the present time, more especially in hospitals, the procedure for disinfecting room is effected by vaporising a disinfectant product in the air. However, the size of the vaporised drops is too great to permit diffusion in the whole of the area of the premises and on the walls. Because of this, the walls, the furniture and the instruments equipping the premises are not treated, and this makes separate treatment of the surfaces necessary by wiping with the aid of a disinfectant product.

The vaporisation or pulverisation of a liquid consists of fragmenting a liquid mass into a multitude of fine drops which are projected into the atmosphere. A fluid, passing through a pipeline including a narrowing of the cross-section (called a Venturi tube), causes an increase in the flow speed of the fluid and a local reduction in the static pressure at the level of said narrowing. The low pressure has the effect of causing expansion at the outlet of the narrowing. This is the Venturi effect. Thus, a liquid carried by a gaseous flow traversing a Venturi undergoes expansion, which causes its fractional distillation into fine drops. Vaporisers generally use this principle. Either the air-and-liquid mixture is produced in an internal chamber, then the mixture is ejected under pressure through an adjuster in the form of a Venturi. Or the gas and the liquid are ejected separately under pressure in the low-pressure area of the Venturi.

The size of the drops produced is relatively large (between about 80 add 200 μm diameter for a delivery of between 3 and 5 ml per minute only) and, because of gravity, the largest portion is deposited in the immediate vicinity of the apparatus, whilst a tiny fraction is dispersed in the air by diffusion. Not only are the most distant areas not treated, but also the nearest surfaces receive drops dispersed in a heterogeneous manner, which have a tendency to fuse together without covering the totality of the surface.

Various apparatuses have been proposed, seeking to increase the propulsion of the pulverised droplets, more especially by mixing the air either at the level of the pulverised jet or in the entirety of the premises to be treated. However, the size of the drops remains considerable, and a humid film is formed in the vicinity of the apparatus.

An apparatus for nebulisation by low-pressure compressed air is also known, and permits a fine mist to be delivered, which is formed by drops of small size (in the order of 0.5 μm or less). This apparatus only functions correctly for deliveries in the order of 2 ml/hour, and this is totally insufficient to ensure the efficient disinfection of premises. By way of example, medical premises such as an operating theatre require between 1 ml and 4 ml of liquid disinfectant per m³, according to current standards.

The present invention proposes to overcome these disadvantages and to provide other advantages by means of a vaporisation apparatus which permits a dry mist (because of this, called a sprayer) to be generated with increased efficiency from a liquid composition containing an active product such as a disinfectant. This apparatus permits premises to be treated completely, rapidly and in a single operation, in fact the atmosphere as well as the walls and equipment. The treatment is effected in a very short time, with reduced consumption of the active product, and this has a notable economic advantage.

This is made possible by the apparatus which is the subject-matter of the present invention, and the nozzle with which it is equipped, which has the capability of pulverising a large volume of liquid into droplets so fine—in the order of between 2 μm and 20 μm diameter (with a mean gauss measurement of between 7 and 15 μm)—that they are dispersed in a homogeneous suspension in all of the surrounding space, without condensation. The fineness of the droplets formed is such that, when they come into contact with a surface, they adhere thereto without combining with one another, in an extremely thin continuous film, the surface retaining its dry appearance. That is why the mist generated by the apparatus according to the invention is described as a “dry mist”.

The invention relates to a nozzle for spraying a liquid into the atmosphere, which nozzle comprises:
a secondary jet 102 connected to means 200 for supplying said liquid and including means 1 for effecting a first fractional distillation of said liquid and an expansion chamber 2;
a principal jet 101 connected to means for generating a gaseous flow 300, including means 3 for effecting a second fractional distillation of said liquid and an outlet orifice 4 to the atmosphere; and
connecting means 5 connecting the expansion chamber 2 and the means 3 for effecting the second fractional distillation of said liquid.

The means for generating a gaseous flow 300 comprise a supply source 301 of gas under pressure, commonly a compressed-air compressor, and a conduit 303 necessary for conveying the gas to the nozzle.

The means for supplying liquid 200 comprise at least one reservoir 201, a solution intended to be vaporised and containing on active substance such as a disinfecting agent, and the conduits 203 and 204, necessary for conveying the product to the nozzle.

In an advantageous manner, the secondary jet 102 is in the form of a cylinder, the central portion of which is occupied by the principal jet 101, which also has a cylindrical configuration, the annular cross-sectional space created thereby forming the expansion chamber 2. Thus, the wall 25, defining a cylindrical conduit 24 appertaining to the principal jet 101, is at one and the same time the separating partition between said principal jet and said expansion chamber.

The first fractional distillation of the liquid and the second fractional distillation of the liquid may be effected by means of conduits in the form of Venturis, the principle of which has been described above.

The means for effecting a first fractional distillation then comprise a first Venturi 6 including a tapering part 8 followed by a calibrated cylindrical portion 9, the latter terminating in the expansion chamber 2. The calibrated cylindrical portion 9 forms a narrowing portion through which the liquid to be pulverised is introduced into the expansion chamber 2. The cross-section of the calibrated cylindrical portion 9 may be greater or smaller, but must be sufficiently narrow for the liquid arriving through the tapering part 8 to undergo acceleration then expansion in the expansion chamber. For example, the diameter of the calibrated cylindrical portion 9 will be fixed at a value of between 0.1 mm and 1.2 mm.

On the other hand, it has been ascertained that the configuration of the tapering part 8 had a certain importance for the quality of the fractional distillation. In the conventional manner, this tapering part has a conical configuration, one and of which is tapered until it has the same diameter as the calibrated cylindrical portion 9 which extends it. According to a preferred embodiment, it may also be in the form of a truncated cone, the smallest end of which has a larger diameter than the diameter of the calibrated cylindrical portion 9 and is adapted thereto through the intermediary of a bearing 27, so that the reduction in cross-section between the supply conduit 203 and the calibrated cylindrical portion 9 is discontinuous.

Preferably, in order to improve the first fractional distillation, the calibrated cylindrical portion 9 terminates in the expansion chamber 2 in a recessed manner relative to the wall 26 of said expansion chamber. The liquid supply conduit 203 may be secured to the nozzle by the wall 26 which defines the expansion chamber. It is then preferably inserted into a hole provided in said wall, to a depth which is less than the thickness of said wall, so that the end of the liquid supply conduit 203 is recessed relative to the internal surface of the wall 26 of the expansion chamber.

The means for effecting the second fractional distillation comprise a second Venturi 7 including a tapering part 10 followed by a cylindrical portion 11 terminating in the atmosphere through the outlet orifice 4. The gaseous flow under pressure, arriving through the cylindrical conduit 24, sees its pressure increased further in the tapering part 10 of the second Venturi 7 and undergoes considerable acceleration at the level of the cylindrical portion 11, then low pressure at the outlet 4. The low pressure has the complementary effect of creating a suction force on the connection means 5 connecting the principal jet 101 to the secondary jet 102. Because of this, the liquid prior to fractional distillation, situated in the expansion chamber 2, is sucked into the Venturi 7 and forms a fluid mixed with the gas. Since the mixed gas-and-liquid fluid penetrates into the low-pressure area, the liquid then undergoes a second fractional distillation.

The connection means 5 comprise at least one connection conduit 12, which connects the expansion chamber 2 and the cylindrical portion 11 of the second Venturi 7. In an advantageous manner, said connection means 5 comprise a plurality of connection conduits 12 disposed radially relative to the cylindrical portion 11 of the second Venturi 7. For example, 4 connection conduits can terminate in the cylindrical portion 11. Of course, for a better flow of the streams, it is preferable that the connection conduits 12 terminate in a symmetrical distribution in the cylindrical portion 11. A homogeneous gas-and-liquid mixture is thereby produced, without disturbing the gaseous flow into which the liquid is incorporated.

Another characteristic of the nozzle according to the invention relates to the configuration of the expansion chamber. In fact, it is apparent that the geometry of said chamber influences the fineness of the droplets formed and their homogeneity, this phenomenon being attributed by hypothesis to a cavitation effect associated with the eddies caused by a structure “formed from staircase steps”. That is why the expansion chamber 2 preferably has sudden variations in thickness along the longitudinal axis. For example, 4 thicknesses may be provided, going from a few tenths of a millimetre up to a few millimetres, the greatest thickness being situated in the central area of the expansion chamber 2. In a particularly advantageous manner, said chamber has the smallest thickness in the vicinity of the connection conduits 12.

According to another characteristic, the spray nozzle according to the invention additionally comprises means for effecting a third fractional distillation of the liquid to be vaporised. This third fractional distillation is preferably effected by sonic vibration. The nozzle according to the invention is than equipped with an ultrasonic resonator 21 and a resonance chamber 22, said resonator and said resonance chamber being connected to the outlet orifice 4 in the axis of the principal jet 101. The mixed fluid ejected from the orifice 4 is thus subjected to an ultrasonic field which causes a new fragmentation of the liquid particles, more especially of the largest of these particles, into finer particles. In this manner, a pulverised mist is produced in which the droplets are of a more homogeneous dimension.

It is desirable that the product delivered by the nozzle according to the invention may be delivered at the various delivery rates in order to spray larger or smaller quantities of product without increasing the treatment time and without the operator having to carry out delicate and complex adjustments. Now, an increase in the gaseous flow in the principal jet will not lead to an increase in the vaporised delivery, since too high a pressure would render inoperative the suction of the liquid at the level of the second Venturi 7. That is why it is preferable to act on the delivery of liquid entering the nozzle, for example at the level of the means for effecting the first fractional distillation. In the case where the first fractional distillation is effected by means of a Venturi 6, the diameter of the calibrated cylindrical portion 9 of said Venturi must be different according to the desired delivery. For this, two nozzles may be used, the calibrated cylindrical portion 9 of which nozzles will be of a different diameter.

Also, in an advantageous manner, a single spray nozzle including a plurality of calibrated cylindrical portions of different diameter may be used.

Thus, according to one particular embodiment of the invention, the nozzle includes two first Venturi 6 and 6′, respectively comprising a tapering part 8 and 8′ followed by a calibrated cylindrical portion 9 and 9′ terminating in the expansion chamber 2, said calibrated cylindrical portions having a different diameter. For example, a first calibrated cylindrical portion will have a diameter of 0.4 mm, and a second calibrated cylindrical portion will have a diameter of 0.9 mm. Moreover, the first Venturis 6 and 6′ are separately connected to the liquid supply means 200 by the conduits 203 and 204 respectively, so that the liquid may be introduced either through one or through the other, alternately. Said first Venturis are preferably placed symmetrically on each side of the expansion chamber 2.

It is understood that, in the present description, the liquid supply means for the nozzle indifferently comprise one or two first Venturis, what applies to one being able to be applied similarly to the other. Moreover, one nozzle including more than two first Venturis, for example 3 or 4 or more, could equally be used. Although it is not described in detail in the present application, such a nozzle can easily be produced by a person skilled in the art, in the light of the characteristics of the present description and of the illustrated examples.

The spray nozzle according to the invention is intended to be integrated in an apparatus which provides for its supply with fluids and fulfils other functions, such as checking and regulating during the treatment of premises, displacement or other functions. An object of the present invention is therefore also an apparatus for spraying a liquid into the atmosphere, comprising:
a spray nozzle 100 according to any of the preceding claims;
means 300 for supplying gas under pressure, said means being connected to the principal jet 101;
means 200 for supplying liquid, said means including a reservoir 201 containing said liquid, the orifice 202 of which is connected to the secondary jet 102; and
means 400 for checking and regulating the fluids.

In an advantageous manner, in the apparatus according to the invention, the reservoir 201 is placed at a level such that the orifice 202 of said reservoir is lower than the spray nozzle 100. The supply of liquid is then effected by suction, In order for the suction of the liquid to be effected with a quasi constant force, the apparatus according to the invention preferably comprises means for checking and regulating the level of the liquid in the reservoir 201 during use.

In a general manner, the various pneumatic and hydraulic circuits which ensure the supply of liquid and gas to the nozzle may be fitted with a system, preferably operation of the apparatus. Such systems are advantageously designed to control the regulation of the fluid parameters in order to ensure a linear operation of the apparatus.

A method of spraying a liquid into the atmosphere is another object of the present invention. It comprises steps which consist of:
effecting a first fractional distillation of said liquid by suction through a conduit 203 (or alternatively 204), which has a first Venturi 6 (or 6′) terminating in an expansion chamber 2 which is subjected to a negative pressure; and
effecting a second fractional distillation of said liquid by suction through means 5 for connecting the expansion chamber 2 to a second Venturi 7 supplied by a gaseous flow under pressure.

According to an advantageous characteristic, the gas supply pressure of the second Venturi 7 is regulated so that the pressure prevailing at the outlet 4 of said second Venturi is lower than the pressure prevailing in the expansion chamber 2. For a linear operation, the liquid supply is preferably effected from a reservoir 201, the liquid level of which is maintained within a limited defined range during the operation.

The method of spraying according to the invention is preferably effected by means of a spray nozzle such as that described hereabove. In particular, the first and second fractional distillations are effected by means of a spray nozzle comprising:
a secondary jet 102 connected to means 200 for supplying said liquid and including means 1 for effecting a first fractional distillation of said liquid and an expansion chamber 2;
a principal jet 101 connected to means for generating a gaseous flow 300, including means 3 for effecting a second fractional distillation of said liquid and an outlet orifice 4 to the atmosphere; and
means 5 for connecting said secondary jet to said principal jet, connecting the expansion chamber 2 and the means 3 for effecting the second fractional distillation of said liquid.

Preferably, the first fractional distillation of the liquid and the second fractional distillation of the liquid are effected by means of conduits in the form of Venturis, and
the pressure of the gaseous flow in the principal jet 101 is between 2.5 bars and 3.5 bars, preferably 3 bars; and
the diameter of the calibrated cylindrical portion 9 of the first Venturi 6 is between 0.3 mm and 1 mm, permitting a delivery of liquid of between 15 ml/min and 30 ml/min.

For good operation, the density of the pulverised liquid must be between 0.95 and 1.05. Since the diluted solutions, such as the compositions comprising a disinfectant product, generally have a density close to that of water, this characteristic does not form a limiting factor for the use of the apparatus according to the invention.

The method using the apparatus according to the invention in the conditions specified above is capable of pulverising between 15 ml and 40 ml of liquid per minute in the form of a mist formed by droplets, the average diameter (mean gauss measurement) of which is between 7 μm and 15 μm.

For a more advanced homogeneity of the pulverised droplets, the method of spraying according to the invention may additionally comprise a step consisting of effecting a third fractional distillation of the liquid by ultrasonic resonance.

As explained previously, a spray nozzle such as that described, or a spraying apparatus including such a nozzle, is intended for all sorts of applications which require the vaporisation of a liquid product in the form of a very fine mist. More especially it is perfectly suitable for disinfecting premises used for medical, paramedical, food-processing or other purposes.

Other characteristics and advantages will appear on reading one embodiment and the accompanying drawings.

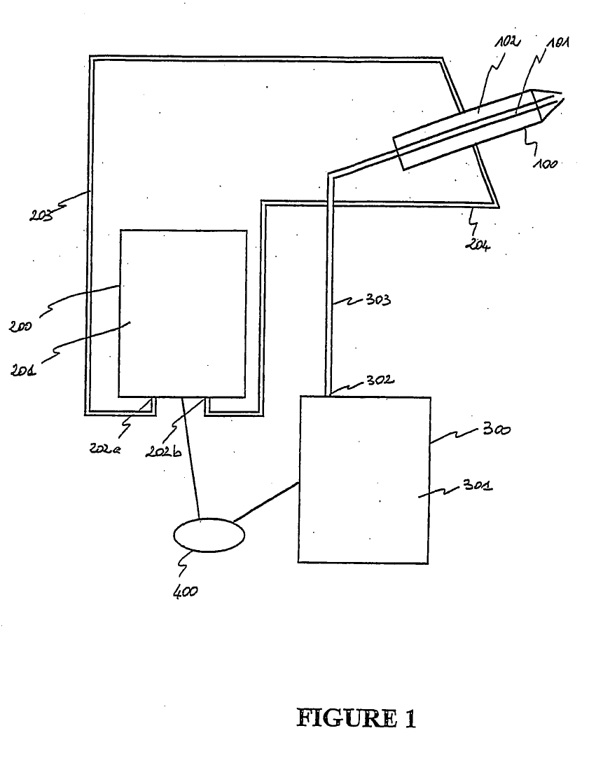

FIG. 1 illustrates an overall view of a spraying apparatus having two inlet paths and an ultrasonic resonator, according to the invention;

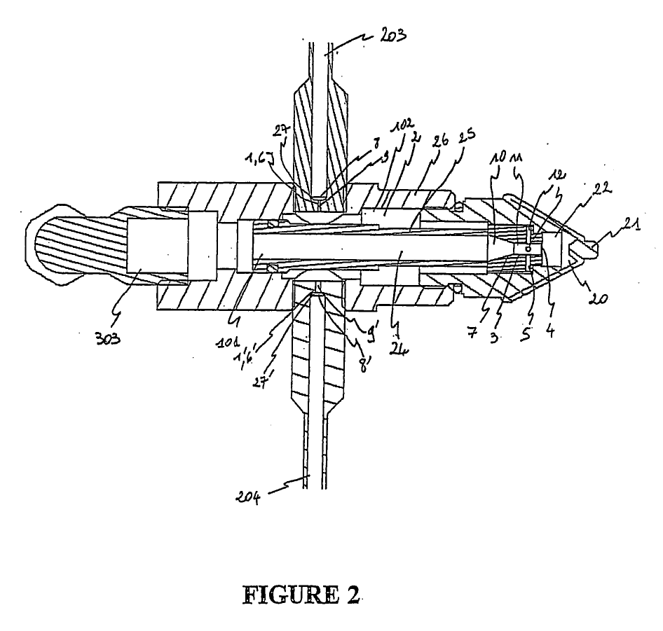

FIG. 2 is a longitudinal cross-sectional view of a spray nozzle having two inlet paths and an ultrasonic resonator, according to the invention; and

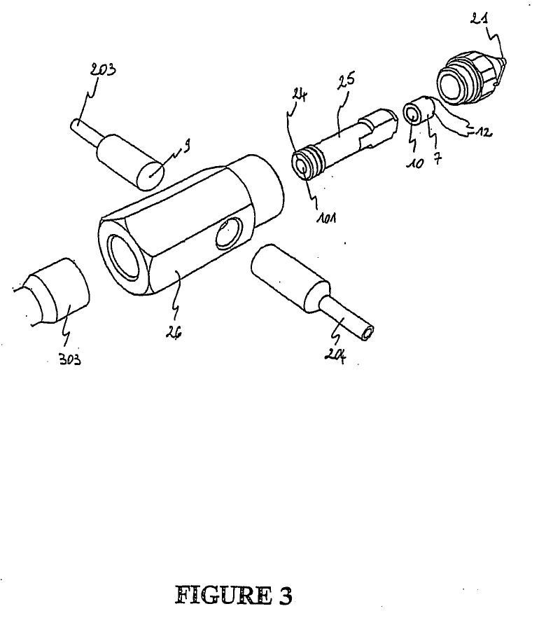

FIG. 3 is an exploded view of a spray nozzle having two inlet paths and an ultrasonic resonator, according to the invention.

### EXAMPLE 1

In FIG. 1, the apparatus for spraying a liquid into the atmosphere comprises a spray nozzle 100, means 200 for supplying liquid, means 300 for generating a gaseous flow and means 400 for checking and regulating the fluids. The means 200 for supplying liquid comprise a reservoir 201 which has the orifices 202a and 202b, connected by the conduits 203 and 204 respectively to the secondary jet 102 of the nozzle 100. The means 300 for generating a gaseous flow comprise a compressed-air supply 301, which has an orifice 302 connected to the principal jet 101 of the nozzle 100 by the conduit 303.

The reservoir 201, containing the liquid to be pulverised, is placed below the nozzle 100. It is controlled by the means 400 for checking and regulating the level of the liquid. The regulating and checking means 400 also permit the liquid supply to be controlled by one or other of the conduits 203 and 204, alternatively. The supply of gas under pressure 301 is assured by an air compressor. The nozzle 100, which equips the spraying apparatus, may be that which is described in detail in Example 2 hereinafter.

### EXAMPLE 2

The vaporisation nozzle illustrated in FIG. 2 has the general configuration of a cylinder comprising two liquid supply conduits 203 and 204. It has an expansion chamber 2, which has a cylindrical configuration and encloses the conduit 24, also of cylindrical configuration. Thus, the wall 25 defining the cylindrical conduit 24 is at one and the same time the separation partition with the expansion chamber 2.

According to a first Mode of operation, which only uses the supply conduit 203, the expansion chamber 2 is supplied with liquid through the first Venturi 6, which includes the tapering part 8 having a bearing 27 followed by the calibrated cylindrical portion 9 terminating in the expansion chamber 2. The calibre (diameter) of the cylindrical portion 9 is 0.4 mm here, and this corresponds to a low delivery operation of the nozzle. The assembly forms the secondary jet 102.

The supply conduit 203 is secured in the external wall 26 of the nozzle which defines the expansion chamber 2, at a depth which is less than the thickness of the wall 26, so that the calibrated cylindrical portion 9 is recessed relative to the internal surface of the wall 26. In the present example, for optimum operation, the end of the supply conduit 203 is recessed by between 1.5 mm and 3 mm relative to the internal surface of the wall 26 of the expansion chamber 2.

According to a second mode of operation, using the second supply conduit 204, the expansion chamber 2 is supplied with liquid through the first Venturi 6′, which includes the tapering part 8′ followed by the calibrated cylindrical portion 9′ terminating in the expansion chamber 2. The calibre (diameter) of the calibrated cylindrical portion 9′ is 0.9 mm here, and this corresponds to a high delivery operation of the nozzle.

As for the first supply conduit 203, the Supply conduit 204 is secured in the external wall 26 of the nozzle which defines the expansion chamber 2, so that the calibrated cylindrical portion 9′ is recessed by between 1.5 mm and 3 mm relative to the internal surface of the wall 26 of the expansion chamber 2.

The conduits 203 and 204 are placed symmetrically on each side of the expansion chamber 2. Each of said conduits is connected to the liquid supply means, so that the liquid supply may be effected selectively by means of one or the other, and this permits higher or lower delivery to be selected. Whether one or other of the conduits 203 or 204 is in operation, the liquid is dispersed in the totality of the space of the expansion chamber 2 around the wall 25, so that the subsequent transportation of the fluid into the nozzle will be identical, whichever path is used.

For the rest of the description, it matters little to know through which of the two conduits the liquid is introduced, this remark applying also in the case of a nozzle which only includes a single liquid supply conduit.

Moreover, the expansion chamber 2 has sudden variations of thickness along the longitudinal axis. In the present example, 4 thicknesses are illustrated, going from a few tenths of a millimetre to a few millimetres, the thickest being in the central area of the expansion chamber 2. Said chamber has the smallest thickness in the vicinity of the connection conduits 12, with a value of 0.5 mm.

The central jet 101, supplied with compressed air through the supply conduit 303, comprises the cylindrical conduit 24 and the second Venturi 7 including the tapering part 10 followed by the cylindrical portion 11 which terminates in the atmosphere through the outlet orifice 4.

The connection means 5 connect: the principal jet 101 and the secondary jet 102 through an assembly of four connection conduits 12, connecting the expansion chamber 2 and the cylindrical portion 11 of the second Venturi 7. The connection conduits 12 are disposed radially relative to the axis of the cylindrical portion 11 according to a symmetry of the order of 4.

The nozzle illustrated here is also fitted with an ultrasonic resonator 21 and a resonance chamber 22. The resonator 21 and the resonance chamber 22 are controlled by the outlet orifice 4 in the axis of the principal jet 101. The dimensions of the resonator and its relative position are determined in such a manner that the jet of mixed fluid, ejected through the outlet orifice 4, is subjected to the ultrasonic field, causing the fragmentation of the liquid particles into finer particles. A nozzle head of this type, comprising a pulverisation adjuster associated with an ultrasonic resonator, is marketed by a specialised company such as PNR (France).

### EXAMPLE 3

The method, described hereinafter, of spraying a liquid into the atmosphere is carried out by means of the apparatus described in Example 1, comprising the nozzle such as described in Example 2.

A first fractional distillation of the liquid is effected by suction through the first Venturi 6 terminating in the expansion chamber 2, then a second fractional distillation of the liquid is effected by suction through the connection conduits 12 connecting the expansion chamber 2 and the cylindrical portion 11 of the second Venturi 7. The compressed-air supply 301 comprises an air compressor capable of delivering a pressure of between 2.8 and 3.2 bars, which is regulated here to 3 bars.

The gaseous flow under pressure, brought by the cylindrical conduit 24, undergoes acceleration in the second Venturi 7, then expansion at the outlet 4 to the atmosphere, causing the fluid occupying the expansion chamber 2 to be sucked through the connection conduit 12. Since the expansion chamber 2 is at low pressure because of this, a suction of liquid through the first Venturi 6 occurs. The calibre of the cylindrical portion 9 of the first Venturi 6 is fixed at 0.4 mm. The delivery of pulverised liquid, in the conditions described, is 18 ml/min.

When a higher delivery is desired, the nozzle is supplied through the conduit 204. The liquid penetrates into the expansion chamber 2 through the cylindrical portion 9′ of the first Venturi 6′. The calibre of the cylindrical portion 9′ of the first Venturi 6′ is fixed at 0.9 mm. The delivery of pulverised liquid, in the conditions described, is 30 ml/min.

In order for the spraying parameters to remain substantially constant during a period of use, the checking and regulating system 400 maintains the level of the liquid in the reservoir 201 within a predetermined range.

Moreover, in order to obtain optimum dispersion of the product in the premises treated, the axis of the nozzle has an inclination of between 20° and 30° relative to a horizontal plane.

1. Nozzle for spraying a liquid into the atmosphere, characterised in that it comprises:
a secondary jet (102) connected to means (200) for supplying said liquid and including means (1) for effecting a first fractional distillation of said liquid and an expansion chamber (2);
a principal jet (101) connected to means for generating a gaseous flow (300), including means (3) for effecting a second fractional distillation of said liquid and an outlet orifice (4) to the atmosphere; and
means (5) for connecting said secondary jet to said principal jet,
connecting the expansion chamber (2) and the means (3) for effecting the
second fractional distillation of said liquid,

2. Spray nozzle according to claim 1, characterised in that the secondary jet (102) is in the form of a cylinder, the central portion of which is occupied by the principal jet (101), which also has a cylindrical configuration, the annular cross-sectional space created thereby forming the expansion chamber (2).

3. Spray nozzle according to claim 1, characterised in that the first and second fractional distillation means (1, 3) comprise a first and second Venturi (6, 7) respectively.

4. Spray nozzle according to claim 3, characterised in that the first Venturi (6) comprises a tapering part (8) followed by a calibrated cylindrical portion (9) terminating in the expansion chamber (2).

5. Spray nozzle according to claim 4. characterised in that the tapering part (8) is in the form of a truncated cone, which is adapted to the calibrated cylindrical portion (9) through the intermediary of a bearing (27) so that the reduction in cross-section between the supply conduit (203) and the calibrated cylindrical portion (9) is discontinuous.

6. Spray nozzle according to claim 4, characterised in that the calibrated cylindrical portion (9) terminates in the expansion chamber (2) in a recessed manner relative to the wall of said expansion chamber.

7. Spray nozzle according to claim 3, characterised in that the second Venturi (7) includes a tapering part (10) followed by a cylindrical portion (11) terminating in the atmosphere through the outlet orifice (4).

8. Spray nozzle according to claim 1, characterised in that the means (5) for connection the secondary jet (102) to the principal jet (101) comprise a plurality of conduits (12) disposed radially between the expansion chamber (2) and the cylindrical portion (11) of the second Venturi.

9. Spray nozzle according to claim 1, characterised in that the expansion chamber (2) has sudden variations in thickness along the longitudinal axis.

10. Spray nozzle according to claim 9, characterised in that the expansion chamber (2) has the smallest thickness in the vicinity of the connection conduits (12).

11. Spray nozzle according to claim 1, characterised in that it additionally comprises means (20) for effecting a third fractional distillation of said liquid.

12. Spray nozzle according to claim 11, characterised in that said third fractional distillation means comprise an ultrasonic resonator (21) and a resonance chamber (22) connected to the outlet orifice in the axis of the principal jet.

13. Spray nozzle according to claim 1, characterised in that said first fractional distillation means (1) for said liquid comprise two first Venturi (6, 6′) terminating in the expansion chamber (2).

14. Spray nozzle according to claim 13, characterised in that said first two Venturi (6, 6′) each comprise a tapering part (8, 8′) followed by a calibrated cylindrical portion (9, 9′), said calibrated cylindrical portion having a different diameter for each first Venturi.

15. Apparatus for spraying a liquid into the atmosphere, characterised in that it comprises:
a spray nozzle (100) claim 1;
means (300) for supplying gas under pressure, said means being connected to the
principal jet (101);
means (200) for supplying liquid, said means including a reservoir (201)
containing said liquid, the orifice (202) of which is connected to the secondary jet (102); and
means (400) for checking and regulating the fluids.

16. Apparatus according to claim 15, characterised in that the reservoir (201) is placed at a level such that the orifice (202) of said reservoir is lower than the spray nozzle (100).

17. Method of spraying a liquid into the atmosphere, said method comprising steps which consist of:
effecting a first fractional distillation of said liquid by suction through a conduit (203, 204), which has a first Venturi (6, 6′) terminating in an expansion chamber (2) which is subjected to a negative pressure; and
effecting a second fractional distillation of said liquid by suction through means (5) for connection the expansion chamber (2) to a second Venturi (7) supplied by a gaseous flow under pressure.

18. Method according to claim 17, characterised in that the gas supply pressure of the second Venturi (7) is regulated so that the pressure prevailing at the outlet (4) of said second Venturi is lower than the pressure prevailing in the expansion chamber (2).

19. Method of spraying according to claim 18, characterised in that the first and second fractional distillations are effected by means of a spray nozzle according to one of claims 1 to 13, and
the pressure of the gaseous flow in the principal jet (101) is between 2.5 bars and 3.5 bars,
preferably 3 bars; and
the diameter of the calibrated cylindrical portion (9) of the first Venturi (6) is between 0.3 mm and 1 mm, permitting a delivery of liquid of between 15 ml/min and 40 ml/min.

20. Method of spraying according to claim 17, characterised in that it additionally comprises a step consisting of effecting a third fractional distillation of the liquid by ultrasonic resonance.

21. Use of a spray nozzle according to claim 1, for disinfecting premises used for medical, paramedical or food-processing purposes.
